(19) United States
(12) Patent Application Publication
(10) Pub. No.: US 2013/0328324 A1
(43) Pub. Date: Dec. 12, 2013

(54) LOCKING DEVICE

(71) Applicant: Te-Yu Chen, Pingtung City (TW)

(72) Inventor: Te-Yu Chen, Pingtung City (TW)

(21) Appl. No.: 13/492,937

(22) Filed: Jun. 11, 2012

(51) Int. Cl. E05C 19/06

(52) U.S. Cl. 292/71

(57) ABSTRACT

The locking device contains a latch element and an elastic element. The latch element has a middle bulge and a first bulge and a second bulge to the lateral sides of the middle bulge. The contour of the three bulges is curved. The latch element has a downward extended shaft and two positioning pins vertically extended from the two major faces of the latch element. The elastic element is sleeved over the shaft. The locking device has sliding slots on its casing's front and back faces for the accommodation of the positioning pins, respectively. The latch element is positioned beneath an axle of the locking device's handle. The axle has a notch so that, when the handle is turned to open a door, the middle bulge of the latch element would be embedded into the notch so that the door remains open to avoid its mistakenly closing.

### TECHNICAL FIELD OF THE INVENTION

The present invention is generally related to locking devices for doors, and more particularly to a locking device having a latch element capable of keeping the locking device in an open state so as to avoid that a door is mistakenly closed.

### DESCRIPTION OF THE PRIOR ART

As shown in FIG. 1, a conventional locking device 1 has the axle 11 of its handle (not shown) engages a connecting rod 12. When the handle is turned to open a door (also not shown), the axle 11 drives the connecting rod 12 to pull a lock tongue 13 out of the door's frame and as such the door is opened. When the handle is release, the axle 11 is restored, the lock tongue 13 is pushed back into the door frame, and the door is locked again automatically. Originally for security purpose, this design sometimes causes inconvenience when people exit the house and will return only after a short while and therefore do not have the key with them. They are often locked outside the door because of this design.

### SUMMARY OF THE INVENTION

A major objective of the present invention is therefore to provide a novel locking device where the door would remain open after the handle is turned and released so as to prevent the door from mistakenly closing.

The locking device contains a latch element and an elastic element. The latch element has a middle bulge and a first bulge and a second bulge to the lateral sides of the middle bulge. The contour of the three bulges is curved. The latch element has a downward extended shaft and two positioning pins vertically extended from the two major faces of the latch element. The elastic element is sleeved over the shaft. The locking device has sliding slots on its casing's front and back faces for the accommodation of the positioning pins, respectively. The slots are configured so that the latch element is positioned beneath an axle of the locking device's handle. The axle has a notch so that, when the handle is turned to open a door, the middle bulge of the latch element would be embedded into the notch so that the door remains open to avoid its mistakenly closing.

The foregoing objectives and summary provide only a brief introduction to the present invention. To fully appreciate these and other objects of the present invention as well as the invention itself all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic sectional diagram showing a conventional locking device.

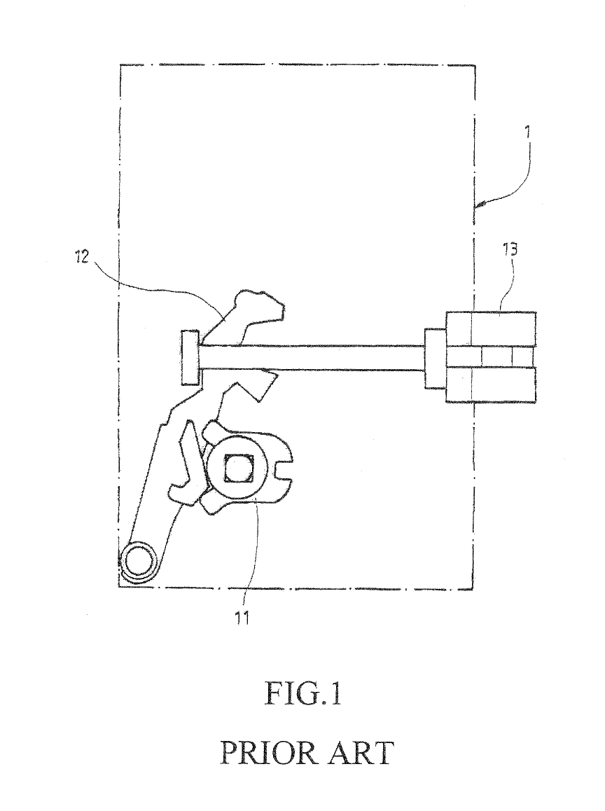

FIG. 2 is a schematic sectional diagram showing a locking device according to an embodiment of the present invention.

FIG. 3 is a perspective diagram showing a latch element of the locking device of FIG. 2.

FIG. 4 is a schematic sectional diagram showing the locking device of FIG. 2 when the locking device is engaged to open a door.

FIG. 5 is a schematic sectional diagram showing the locking device of FIG. 4 when the door is opened.

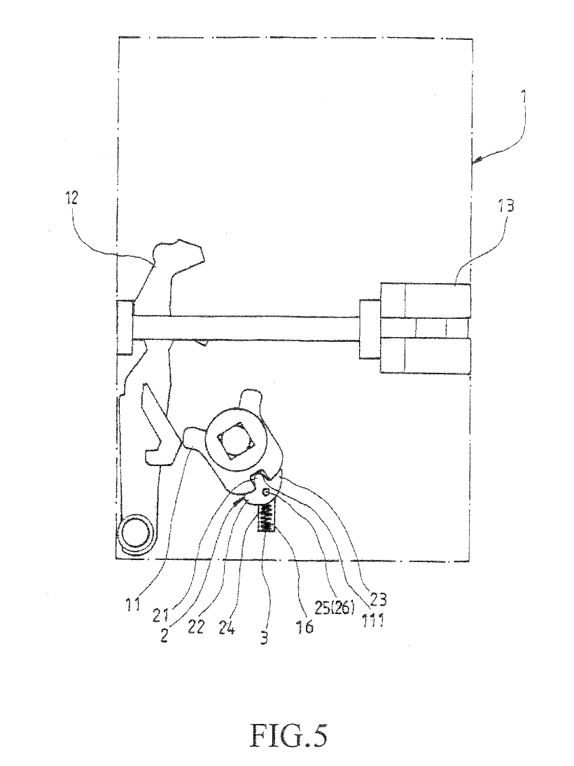

FIG. 6 is a schematic sectional diagram showing the locking device of FIG. 2 when the locking device is engaged to close a door.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

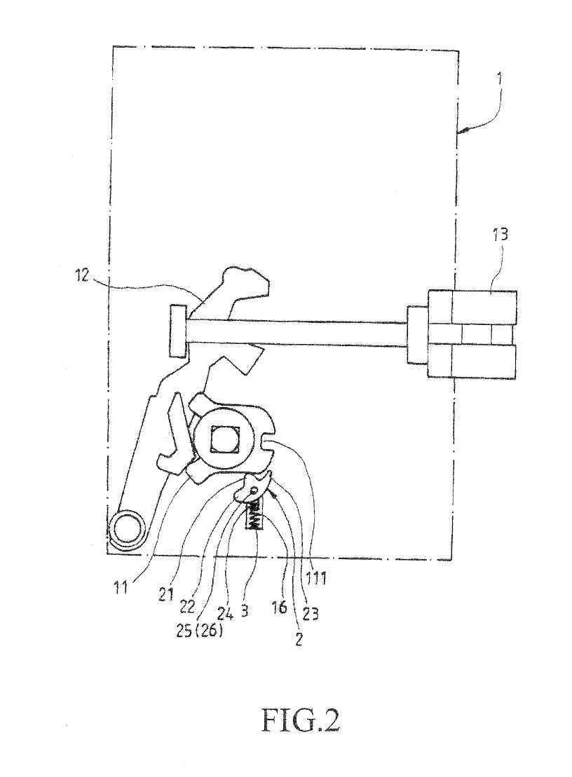

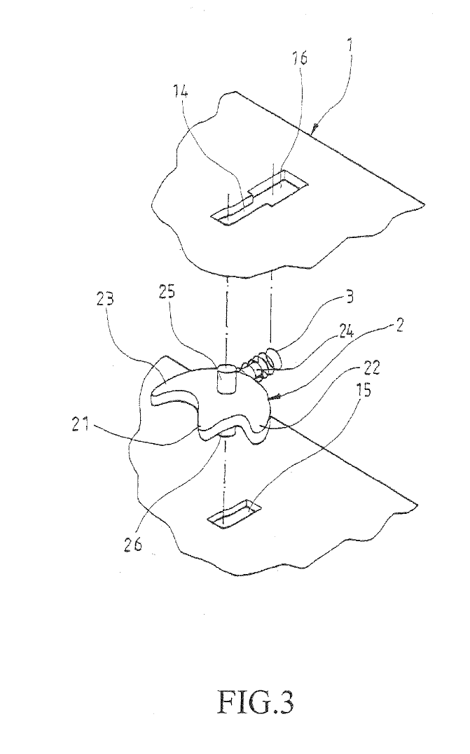

As shown in FIGS. 2 and 3, a locking device 1 according to an embodiment of the present invention contains a latch element 2 and an elastic element 3. The latch element 2 roughly has an E-like shape with a middle bulge 21 (in the present embodiment, the middle bulge 21 has a wider base and a sharper tip) and two lateral bulges referred to as a first bulge 22 and a second bulge 23. The contour of the three bulges 21, 22, and 23 are curved.

The latch element 2 has a downward extended shaft 24. Two positioning pins 25 and 26 are vertically extended from the two major faces of the latch element 2.

The elastic element 3 is sleeved over the shaft 24 and preferably is a helical spring.

For the installation of the latch element 2, the locking device 1 has sliding slots 14 and 15 on its casing's front and back faces for the accommodation of the positioning pins 25 and 26, respectively. The elastic element 3 is then embedded in a positioning slot 16 on one of the front and back faces. The slots are configured so that the latch element 2 is positioned beneath the axle 11 of the locking device's handle. The axle 11 has a notch 111 so that, when the handle is turned to open a door (not shown), the middle bulge 21 of the latch element 2 would be embedded into the notch 111 so that the door remains open to avoid its mistakenly closing.

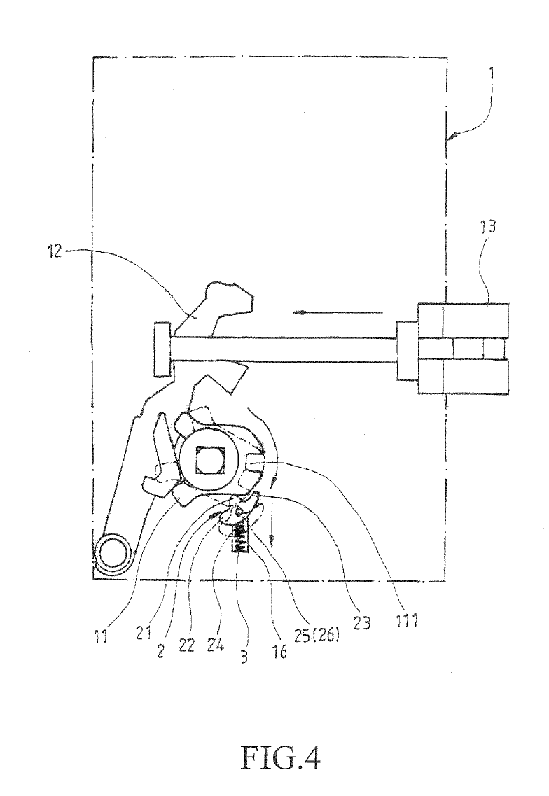

As shown in FIG. 4, when the door is required to be open for a short while, the handle of the locking device 1 is turned clockwise. The axle 11 engages a connecting rod 12 which in turn pulls a lock tongue 13 out of a door frame (not shown). As the axle 11 is turned, since the contour of the middle bulge 21 is curved and the positioning pins 25 and 26 are confined in the sliding slots 14 and 15, the latch element 2 is pushed downward. As shown in FIGS, as the axle 11 is further turned, the lock tongue 13 is retracted inside the locking device 1 and the door is opened. As the notch 111 passes over the middle bulge 21, the latch element 2 is moved upward by the expansion of the elastic element 3 and the middle bulge 21 is embedded into the notch 111. In the meantime, the first and second bulges 22 and 23 further confine the axle 11 laterally. As the contours of the bulges 21, 22, and 23 are curved, the interaction between the latch element 2 and the axle 11 is smooth and accurate. The lock tongue 13 as such remains retracted and the door is kept open. For people who want to exit the door for a short while, they do not need to worry that the door would be mistakenly closed and they are locked outside the door.

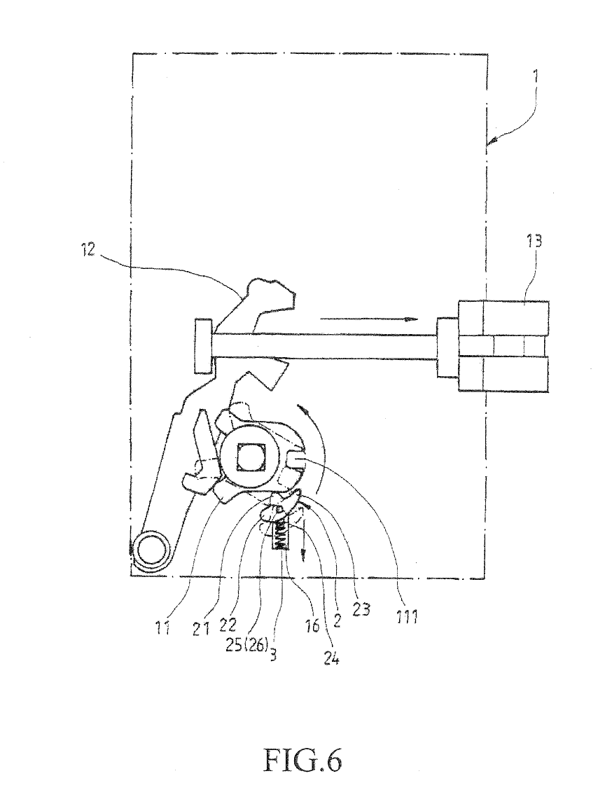

As shown in FIG. 6, in order to close the door, the handle is just turned counterclockwise, the axle 11 and therefore the connecting rod 12 are restored, and the lock tongue 13 is pushed outside the casing of the lock device into the door frame to lock the door. Again, as the contours of the bulges 21, 22, and 23 are curved, the interaction between the latch element 2 and the axle 11 is smooth and accurate. When the axle 11 is turned counterclockwise, the latch element 2 is pushed downward by the axle 11 and, in the meantime, the middle bulge 21 escapes the notch 111 so that the axle 11 can be freely turned furthermore so as to push the lock tongue 13 back into the door frame.

Please note that, if the handle of the locking device 1 is turned counterclockwise in the first place to open the door, the operation of the locking device 1 would be just like a conventional one. Once the door is opened and the handle is released, the axle 11 will be restored and the lock tongue 13 would be pushed to lock the door automatically. The axle 11 is not affected by the latch element 2 at all in this mode of operation.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A locking device for a door, comprising:
a casing having two sliding slots on its two major faces and a positioning slot on one of the two major faces;
a lock tongue inside the casing;
a connecting rod engaging the lock tongue to stick into a frame of the door and to retract into the casing;
an axle engaging the connecting rod, the axle having a notch;
a latch element beneath the axle, the latch element having a middle bulge and a first bulge and a second bulge to the lateral sides of the middle bulge, the latch element having a downward extended shaft and two positioning pins vertically extended from the latch element's two major faces, the positioning pins embedded in the sliding slots, respectively; and
an elastic element sleeved over the shaft and embedded in the positioning slot;
wherein, when the axle is turned and the lock tongue is retracted into the casing through the connecting rod, the notch of the axle moves over the middle bulge of the latch element; by the expansion of the elastic element, the middle bulge is embedded into the notch of the axle; the axle is as such locked and the door therefore remains open.

2. The locking device according to claim 1, wherein the middle bulge has a narrower top end and a wider base.

3. The locking device according to claim 1, wherein the middle bulge, the first bulge, and the second bulge have curved contours.

4. The locking device according to claim 1, wherein the elastic element is a helical spring.
